(19) United States
(12) Patent Application Publication
(10) Pub. No.: US 2013/0295954 A1
(43) Pub. Date: Nov. 7, 2013

(54) METHOD AND APPARATUS FOR TOPOLOGY MAP DETERMINATION

(71) Applicants: Ari Hamalainen, Vantaa (FI); Kari Leppanen, Helsinki (FI); Sami Virtanen, Espoo (FI); Kimmo Kalliola, Helsinki (FI); Mikko Tirronen, Helsinki (FI); Ilari Teikari, Helsinki (FI); Fabio Belloni, Espoo (FI)

(72) Inventors: Ari Hamalainen, Vantaa (FI); Kari Leppanen, Helsinki (FI); Sami Virtanen, Espoo (FI); Kimmo Kalliola, Helsinki (FI); Mikko Tirronen, Helsinki (FI); Ilari Teikari, Helsinki (FI); Fabio Belloni, Espoo (FI)

(73) Assignee: NOKIA CORPORATION, Espoo (FI)

(21) Appl. No.: 13/698,916

(22) PCT Filed: May 21, 2010
(86) PCT No.: PCT/FI10/50413

§ 371 Date: Jul. 24, 2013

(51) Int. Cl. H04W 64/00

(52) U.S. Cl. CPC H04W 64/00
USPC 455/456.1

(57) ABSTRACT

A method for topology map determination comprises detecting at least one remote apparatus by a first apparatus, wherein each of the at least one remote apparatus and the first apparatus is identified by an identification information. The method further comprises determining a local distance information between the first apparatus and at least one of the at least one remote apparatus and receiving at least one distance measurement report from any one or each one of the at least one remote apparatus. The at least one distance measurement report comprises at least one peer identification information of at least one peer apparatus and an associated peer distance information between the remote apparatus and the at least one peer apparatus, and the method further comprises determining a topology map.

### TECHNICAL FIELD

The present application relates generally to mobile localization or positioning. In particular the application relates to device to device communication in a wireless mesh network.

### BACKGROUND

Wireless communication has moved from simply being concerned with conveying verbal information to being more focused on total digital interactivity. While originally limited to voice communication (for example telephone calls on cellular handsets), enhancements in wireless technology have substantially improved ability, quality of service (QoS), speed, etc. These developments have contributed to an insatiable desire for new functionality. Portable wireless apparatuses are no longer just tasked with making telephone calls. They have become integral, and in some cases essential, tools for managing the professional and/or personal life of users.

The effect of this evolving technology may be seen in instances where a plurality of apparatuses have been replaced with a single multifunction device. The functionality that was formally provided by landline telephones and facsimiles, laptop computers, portable digital assistants (PDA), game systems, music players, digital storage devices may be supported in a single digital communication apparatus. The above functionality may be further supplemented through the provision of applications that were not previously available in portable apparatuses (for example directional/tracking features, wireless financial transactions, social networking, etc.).

Wireless (for example cellular) service providers and device manufacturers are continually challenged to deliver value and convenience to consumers by, for example, providing compelling network services, applications, and content. One area of development is the use of device-to-device communication networks and devices to automatically determine information and context about the local environment. For example is an environment where devices or nodes are communication via a mesh network like an ad-hoc network there is a possibilty to exchange information from device to device via one ore more intermediate devices.

### SUMMARY

Various aspects of examples of the invention are set out in the claims.

According to a first aspect of the present invention, discloses a method comprising detecting at least one remote apparatus by a first apparatus, wherein each of the at least one remote apparatus and the first apparatus is identified by an identification information, determining a local distance information between the first apparatus and at least one of the at least one remote apparatus, receiving at least one distance measurement report from any one or each one of the at least one remote apparatus. The at least one distance measurement report comprises at least one peer identification information of at least one peer apparatus and an associated peer distance information between the remote apparatus and the at least one peer apparatus. The method further comprises, and determining a topology map based on the at least one identification information, local distance information, and the at least one distance measurement report. The topology map comprises the at least one remote apparatus and the at least one peer apparatus.

According to a second aspect of the present invention, discloses an apparatus comprising at least one processor configured to detect at least one remote apparatus, wherein each of the at least one remote apparatus and the apparatus is identified by an identification information, determine a local distance information between the apparatus and at least one of the at least one remote apparatus, receive at least one distance measurement report from any one or each one of the at least one remote apparatus. The at least one distance measurement report comprises at least one peer identification information of at least one peer apparatus and an associated peer distance information between the remote apparatus and the at least one peer apparatus. The apparatus further comprises determine a topology map based on the at least one identification information, local distance information, and the at least one distance measurement report. The topology map comprises the at least one remote apparatus and the at least one peer apparatus.

According to a third aspect of the present invention, discloses a method comprising detecting at least one remote apparatus by a first apparatus, wherein each of the at least one remote apparatus and the first apparatus is identified by an identification information, determining a distance information between the first apparatus and at least one of the at least one remote apparatus, generating at least one distance measurement report The at least one distance measurement report comprises for any one or each one of the at least one of the detected remote apparatus the identification information and the distance information. The method further comprises transmitting the at least one generated distance measurement report.

According to a fourth aspect of the present invention, discloses an apparatus comprising at least one processor configured to detect at least one remote apparatus, wherein each of the at least one remote apparatus and the apparatus is identified by an identification information, determine a distance information between the apparatus and at least one of the at least one remote apparatus, generate at least one distance measurement report. The at least one distance measurement report comprises for any one or each one of the at least one of the detected remote apparatus the identification information and the distance information, and the apparatus further comprises transmit the at least one generated distance measurement report.

According to a fifth aspect of the present invention, discloses a computer program, comprising code for detecting at least one remote apparatus by a first apparatus, wherein each of the at least one remote apparatus and the first apparatus is identified by an identification information, code for determining a local distance information between the first apparatus and at least one of the at least one remote apparatus, code for receiving at least one distance measurement report from any one or each one of the at least one remote apparatus. The at least one distance measurement report comprises at least one peer identification information of at least one peer apparatus and an associated peer distance information between the remote apparatus and the at least one peer apparatus. The computer program further comprises code for determining a topology map based on the at least one identification information, local distance information, and the at least one distance measurement report. The topology map comprises the at least one remote apparatus and the at least one peer apparatus when the computer program is run on at lease one processor.

According to a sixth aspect of the present invention, discloses a computer program, comprising code for detecting at least one remote apparatus by a first apparatus, wherein each of the at least one remote apparatus and the first apparatus is identified by an identification information, code for determining a distance information between the first apparatus and at least one of the at least one remote apparatus, code for generating at least one distance measurement report. The at least one distance measurement report comprises for any one or each one of the at least one of the detected remote apparatus the identification information. The computer program further comprises the distance information, and code for transmitting the at least one generated distance measurement report when the computer program is run on at least one processor.

According to another aspect of the present invention, discloses an apparatus comprising means for detecting at least one remote apparatus, wherein each of the at least one remote apparatus and the apparatus is identified by an identification information, means for determining a local distance information between the apparatus and at least one of the at least one remote apparatus, means for receiving at least one distance measurement report from any one or each one of the at least one remote apparatus. The at least one distance measurement report comprises at least one peer identification information of at least one peer apparatus and an associated peer distance information between the remote apparatus and the at least one peer apparatus. The apparatus further comprises means for determining a topology map based on the at least one identification information, local distance information, and the at least one distance measurement report. The topology map comprises the at least one remote apparatus and the at least one peer apparatus.

According to a further more aspect of the present invention, discloses an apparatus comprising means for detecting at least one remote apparatus, wherein each of the at least one remote apparatus and the apparatus is identified by an identification information, means for determining a distance information between the apparatus and at least one of the at least one remote apparatus, means for generating at least one distance measurement report. The at least one distance measurement report comprises for any one or each one of the at least one of the detected remote apparatus the identification information and the distance information. The apparatus further comprises means for transmitting the at least one generated distance measurement report.

### BRIEF DESCRIPTION OF THE DRAWINGS

For a more complete understanding of example embodiments of the present invention, reference is now made to the following descriptions taken in connection with the accompanying drawings in which:

FIG. 1 depicts an example embodiment of a mesh network with wireless apparatuses;

FIG. 2 depicts an example embodiment of a mesh network with wireless apparatuses wherein one apparatus has real position;

FIG. 3a depicts an example simulation result of an estimation of a location map test case;

FIG. 3b depicts an example local topology map and an example remote topology map;

FIG. 3c represents an exemplary embodiment of a rotated remote topology map and a rotated local topology map;

FIG. 3d depicts an exemplary embodiment of a rotated extended topology map;

FIG. 3e depicts exemplary a derotated extended topology map;

FIG. 4 depicts an example embodiment of a packet or message 401 comprising distance measurement report;

FIG. 5 depicts an example embodiment of a beacon comprising distance measurement report;

FIG. 6 depicts an example embodiment of a message for a topology map request;

FIG. 7 depicts an example embodiment of a message for a topology map response;

FIG. 8 depicts an example embodiment of a hardware upon which an embodiment of the invention may be implemented;

FIG. 9 depicts an example embodiment of a wireless node according to one or more aspects described herein;

FIG. 10 depicts a flow diagram of an example distance measurement transmitting process;

FIG. 11 depicts a flow diagram for an example local topology map generation process; and

FIG. 12 depicts a flow diagram for an example topology map distribution process.

### DETAILED DESCRIPTION OF THE DRAWINGS

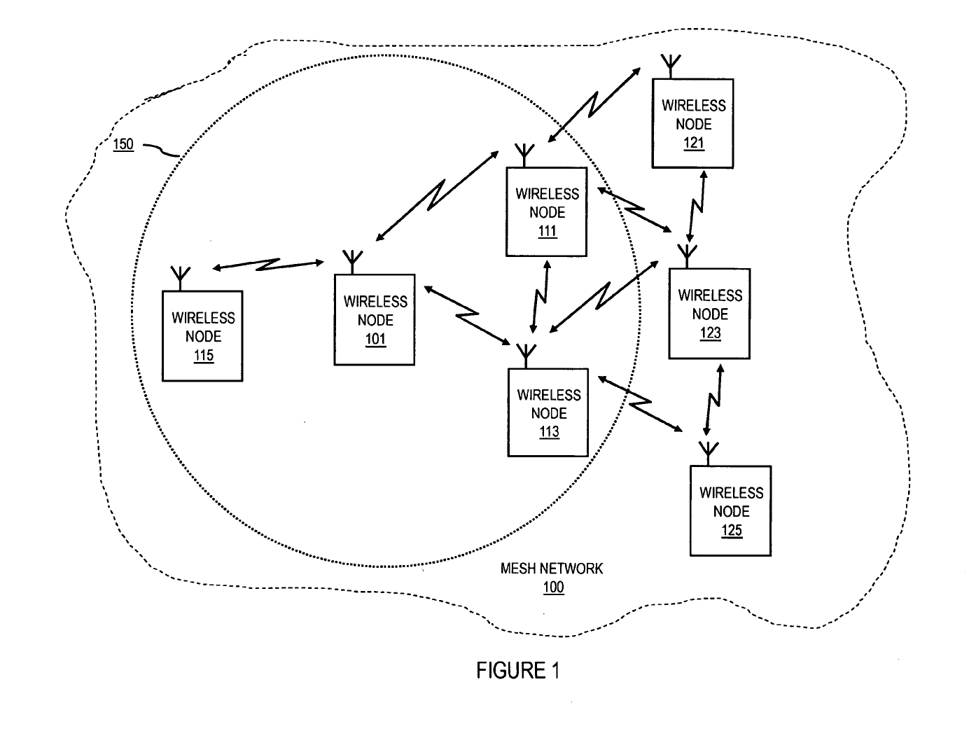

An example embodiment of the present invention and its potential advantages are understood by referring to FIGS. 1 through 12 of the drawings.

FIG. 1 depicts an example embodiment of a mesh network 100 with wireless apparatuses. The wireless apparatuses are for example wireless nodes communicating in the wireless mesh network 100 like for example in an ad-hoc mesh network. Wireless links between the wireless nodes may be based on a short-range communication protocol like for example Bluetooth, Wireless USB (Universal Serial Bus), wireless local area network (WLAN) or any other suitable ad-hoc radio mesh protocols that enables direct communication between devices in a connectionless fashion and allows to carry awareness information. Awareness information refers to any information and/or context about a local environment as well as the users and communication devices within the local environment. By way of example, awareness information may be used to support applications for creating social networks, determining presence, determining contexts associated with a device, advertising and/or searching for information. An apparatus like for example wireless node 101 is configured to communicate awareness information with his neighbor nodes 111, 113 and 115 in a connectionless fashion. Connectionless here refers for example to an ability of node 101 to transmit messages to the neighbor nodes without any prior control signaling for connection setup between any pair of wireless nodes. The neighbor nodes are in the coverage area 150 of the wireless node 101. Wireless node 101 may direct communicate with its neighbor or remote nodes 111, 113 and 115. Wireless node 101 may identify its neighbor nodes by listening on the channel. In the communication area of wireless node 111 are wireless nodes 101, 113, 121 and 123. Wireless nodes 121 and 123 are out of the communication range of wireless mode 101. Consequently, wireless node 101 is not able to communicate and identify the availability of wireless node 121 and 123. In the communication area of wireless node 113 are wireless nodes 101, 111, 123 and 125. Wireless nodes 123 and 125 are out of the communication range of wireless mode 101. Wireless node 101 can not communicate directly with wireless nodes 123 and 125. Thus, apparatus 101 is not able to identify the availability of wireless node 123 and 125.

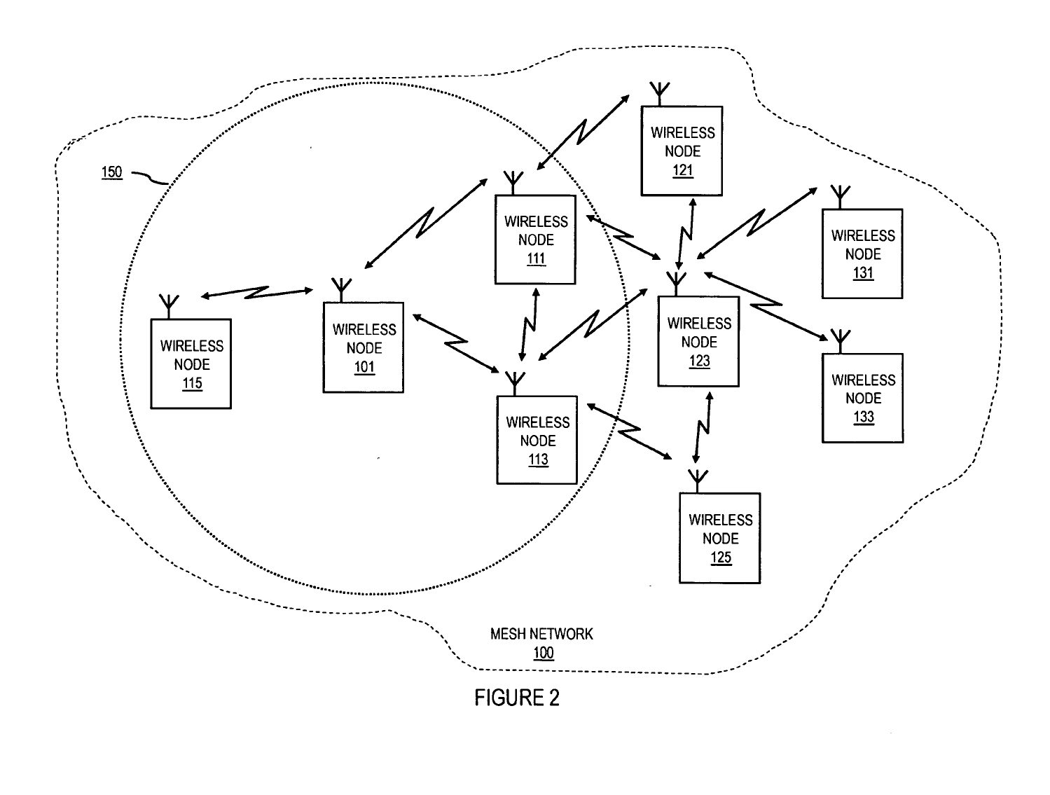

FIG. 2 depicts an example embodiment of a mesh network with wireless apparatuses wherein two additional apparatuses are presented wherein one or both may have a real geographical position. In FIG. 2 apparatuses like for example wireless nodes 101 to 125 are similar to those in FIG. 1. The additional apparatuses are wireless nodes 131 and 133. Each of the wireless nodes 131, 133 may comprises a real or fixed or known geographical position that may be known a priori. For example the real geographical position may be predetermined or obtained from global positing system (GPS) data. The other wireless nodes of FIG. 2 are not able to identify their own positions as they may be located indoor or are not configured to receive GPS data.

A wireless apparatus for example a wireless node or device may transmit one ore more periodic messages that comprise some identification information like a unique address or a media access control address (MAC address/identification) or a temporary identification of the transmitting wireless node. In some short-range communication protocols the periodic messages are known as beacons. A wireless node like for example wireless nodes or terminals may identify the availability of one or more other remote wireless nodes in communication range by listening to the channel and with the identified periodic messages the wireless apparatus is configured to measure the received signal strength indicator (RSSI) towards each of the one ore more remote nodes identified by the identification information. The identified RSSI value may be used to determine the distance information towards a remote node based on EQUATION 1. The distance representation may be in any units. In an embodiment the distance representation may be in meters. In another embodiment the distance representation may be defined in predefined distance categories.

$$Dist = \sqrt{\frac{1}{{10}^{3.9 + \frac{RSSI}{10}}}} \qquad ( EQUATION 1 )$$

In another embodiment the distance information may be determined from phase offset estimation. In further embodiments a wireless node may transmit a request and all remote nodes that may identify the request may response with a response message with similar content as the periodic message. The response messages could be used for a determination of a distance information based methods like time of flight, time of arrival, angle of arrival or phase difference or distance class information.

The wireless node may distribute all its identified distance information towards remote apparatuses together with the respective identification information to other apparatuses. The distribution may be done by transmission of a periodical message or by responding to a received request for a distance information message. The distance information may be used to determine a topology map. A topology map shows relative positions of surrounding wireless nodes with respect to the node that generates the topology map. For example if wireless node 101 estimates a location map or topology map of the wireless node around it, wireless node 101 collects all the distance information from the wireless nodes in its communication range. In this example from nodes 111, 113 and 115. Beside that it collects distributed distance information or distance measurement reports from remote wireless nodes 111, 113. The distributed distance information comprises identification and distance information of peer wireless nodes of the remote wireless node. In an example distance measurement report distributed by wireless node 111 would include distance information and related wireless identification of nodes 101, 113, 121 and 123. Not all of the wireless nodes are in the communication range of wireless node 101. In this example wireless nodes 121 and 123 are out of wireless node 101 communication range.

In an embodiment wireless nodes that are moving rapidly with respect to others that could be determined from a distance measurement history stored in a wireless node are not reported to other wireless nodes. Consequently, they are excluded from the determination of the topology map. In another embodiment the number of distance measurements may be limited by a threshold, for example only distance measurements below a distance threshold (for example available in a restricted area) are distributed to reduce the traffic in the mesh network.

After wireless node 101 collects all the distance information the topology map around wireless apparatus may be determined by a minimization of a cost function. There are more measurements than unknown parameter in the scenario. For example, in case of ten nodes there are 90 measurements of distance or distance estimates available which correspond to 45 pairs of the distance information and the distance of each pair is measured from both ends. Only 18 unknown parameters need to be determined. In this scenario they are x, y coordinates of the nine other wireless nodes with respect to the position of the wireless node 101. Because of this, possible noise in the distance estimates may be suppressed to some extent by the minimization.

In the following embodiment local topology estimation is presented by ranging distance measurements between nodes. The following EQUATION 2 maybe used to determine the f(x, y) cost function for two dimensions.

$$f ( x , y ) = {min}_{x , y} {\sum }_{j = 2}^{N} {\sum }_{i = 1}^{N} {[ {( {x}_{j} - {x}_{i} )}^{2} + {( {y}_{j} - {y}_{i} )}^{2} - {d}_{j , i}^{2} ]}^{2} {S}_{j , i} \qquad ( EQUATION 2 )$$

d_{j,i} represents the distance information, corresponding to estimated distance between wireless nodes j and i.

N represents the number of nodes identified or reported to wireless node

S_{j,i} is used to identify if wireless nodes j and i are in direct communication. It is equal to 1 if j and i can hear each other, otherwise 0. It is also 0 if j=i are the same

x, y represents related coordinates

EQUATION 3 and 4 are used for partial derivates of EQUATION 2 with respect to x's and y's (j=1, . . . , N). EQUATION 3 and 4 are gradient descent optimizations. Not all N positions may be chosen at a time instead only one position may be chosen at a time during the optimization.

$$\begin{matrix}Δ {x}_{j} = sign [ \frac{\partial f ( x , y )}{\partial {x}_{j}} ] = sign [ {\sum }_{i = 1}^{N} 4 [ {( {x}_{j} - {x}_{i} )}^{2} + {( {y}_{j} - {y}_{i} )}^{2} - {d}_{j , i}^{2} ] {S}_{j , i} ( {x}_{j} - {x}_{i} ) ] & ( EQUATION 3 ) \\ Δ {y}_{j} = sign [ \frac{\partial f ( x , y )}{\partial {y}_{j}} ] = sign [ {\sum }_{i = 1}^{N} 4 [ {( {x}_{j} - {x}_{i} )}^{2} + {( {y}_{j} - {y}_{i} )}^{2} - {d}_{j , i}^{2} ] {S}_{j , i} ( {y}_{j} - {y}_{i} ) ] & ( EQUATION 4 )\end{matrix}$$

Sign( ) represents a sign operation. The sign operation controls the step size and may improve the stability.

Δxⱼ represents the changes to x coordinates, j=1, . . . , N

Δyⱼ represents the changes to y coordinates, j=1, . . . , N

To avoid local minima one summand at time may be used. EQUATION 5 and 6 represents the optimized equation. One pair of j and i may be chosen at a time and only those may be updated, not all i,j=1, . . . , N. Pair j and i may be chosen randomly. This adds some ‘noise’ to optimization and may help to avoid local minima.

$$\begin{matrix}Δ {x}_{j} = sign [ \frac{\partial f ( x , y )}{\partial {x}_{j}} ] = sign [ [ {( {x}_{j} - {x}_{i} )}^{2} + {( {y}_{j} - {y}_{i} )}^{2} - {d}_{j , i}^{2} ] {S}_{j , i} ( {x}_{j} - {x}_{i} ) ] & ( EQUATION 5 ) \\ Δ {y}_{j} = sign [ \frac{\partial f ( x , y )}{\partial {x}_{j}} ] = sign [ [ {( {x}_{j} - {x}_{i} )}^{2} + {( {y}_{j} - {y}_{i} )}^{2} - {d}_{j , i}^{2} ] {S}_{j , i} ( {y}_{j} - {y}_{i} ) ] & ( EQUATION 6 )\end{matrix}$$

Δxⱼ represents a change to coordinate xⱼ

Δyⱼ represents a change to coordinate yⱼ

x, y represents related coordinates

d_{j,i} represents the distance information, corresponding to estimated distance between wireless nodes j and i.

S_{j,i} is used to identify if wireless nodes j and i are in direct communication.

For the location map determination following steps may be used:

1. t=0; Nₛₜₑₚₛ=Number of iterations. Parameter α is some small value.

2. t=t+1;

3. Choose j and i randomly.

4. Update xⱼ(t)=xⱼ(t−1)+αΔxⱼ(t), yⱼ(t)=yⱼ(t−1)+αΔyⱼ(t)

5. If t>Nₛₜₑₚₛ, end, else goto 2.

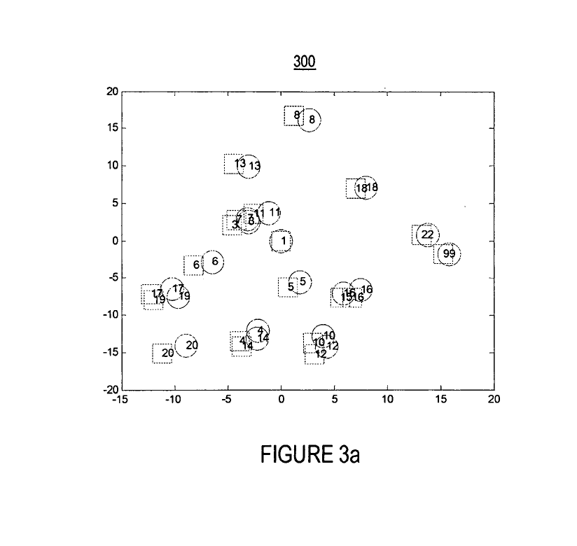

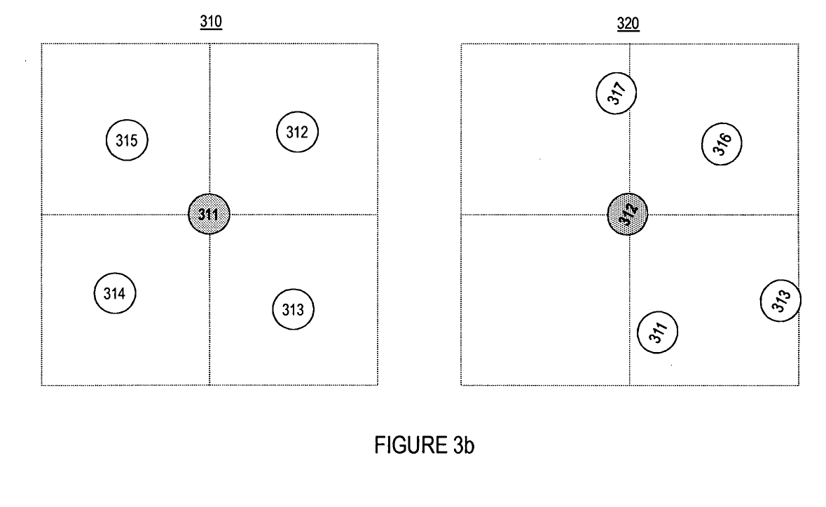

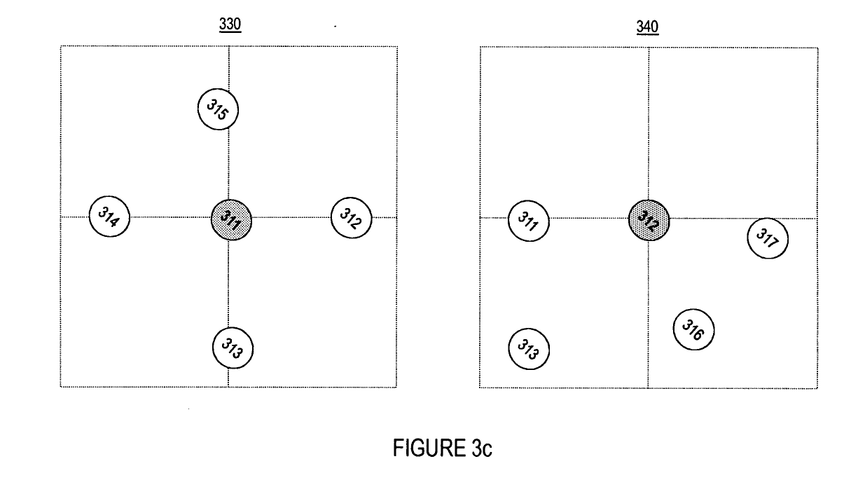

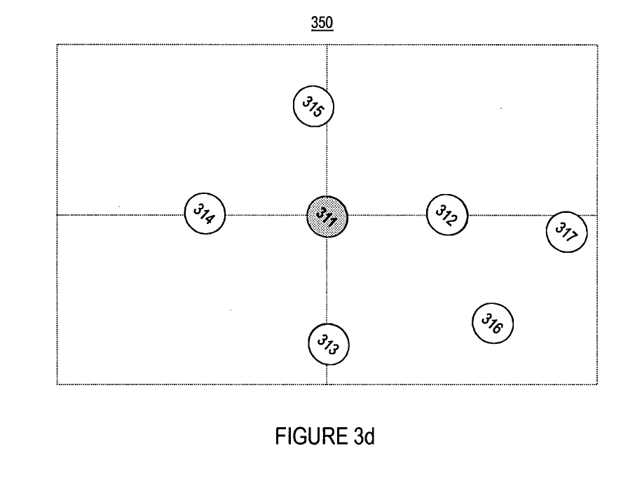

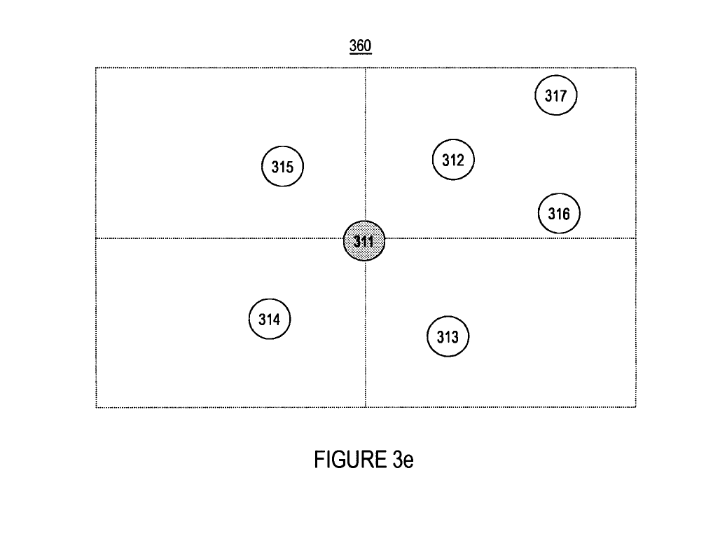

FIG. 3a depicts an example simulation result 300 of an estimation of a location map. FIG. 3a depicts a test case with 20 wireless nodes. The wireless nodes are number 1 to 20. Circles are real locations, squares are estimated locations based on the above presented method. Each wireless node is marked with the respective node number. Wireless node 1 is calculating the topology estimate and is located at position (0, 0). Axes represent in the example the distance in meters. FIG. 3a represents position for each identified node in view of wireless node 1. The position of the over wireless nodes is a relative position in view of wireless node 1.

In an embodiment where the distance measurements reflect a real distance of the wireless nodes (for example based on time-delay measuring methods), the calculated topology represent the real geometry of the wireless nodes. By knowing the real geographical position of two wireless nodes (for example using GPS data or predefined position of a fixed wireless node) the local topology map may reveal the real geographical positions of all the identified and reported wireless nodes.

In another embodiment the cost function may involve besides the x, y coordinates also a third dimension. EQUATION 7 maybe used to determine the f(x, y, z) cost function for three dimensions. The equation is similar to EQUATION 2.

$$f ( x , y , z ) = {min}_{x , y , z} {\sum }_{j = 2}^{N} {\sum }_{i = 1}^{N} {[ {( {x}_{j} - {x}_{i} )}^{2} + {( {y}_{j} - {y}_{i} )}^{2} + {( {z}_{j} - {z}_{i} )}^{2} - {d}_{j , i}^{2} ]}^{2} {S}_{j , i} \qquad ( EQUATION 7 )$$

The local generated topology map may be distributed on a request to other wireless nodes. This allows the requesting wireless node to extend the topology map based on the received topology map and so to present a bigger topology map.

FIG. 3b depicts an example local topology map 310 and an example remote topology map 320. The local topology map 310 is locally determined by wireless node 311. The position of wireless node 311 is assumed to be (0, 0). The local topology map 310 comprises further nodes 312, 313, 313 and 315. The remote topology map 320 may be received from a remote wireless node 312. The position of wireless node 312 is assumed to be (0, 0). Beside that the remote topology map comprises nodes 311, 313, 316 and 317. As a first step the node 311 may align the orientation of the two topology maps. Node 311 may rotate the local topology map so that position of node 311 and position of node 312 are on the X axis. The rotation may be done based on an angle given by an angle of line between node 311 and 312. The rotation may be realized by a complex multiplication of the position of all nodes in the local topology map by conjugate of node 312 positions. The similar rotation may be done for the remote location map. However, in the remote topology map node 312 is in the center position (0, 0). Thus, the conjugate of position node 311 would be used for the complex multiplication for all node positions in the remote topology map. FIG. 3c represents an exemplary embodiment of the rotated remote topology map 330 and the rotated local topology map 340 of FIG. 3b.

Instead or additionally to the rotation there may be a step that comprises a check if the local and remote topology maps are in the same order. If it is the case it may be checked if there is a need for a flip of the remote topology map. This may be realized by checking the signs of y coordinates in the local and the remote topology map. If they are not matching with the local topology map the remote topology map is flipped or mirrored. The y coordinates may be multiplied by −1 so that the local and remote topology map is in the same order. If they are matching there may be no need for any corrections.

The next step may require that the rotated remote topology map is shifted so that node 311 is the center node in the rotated remote topology map. For this an offset value is determined between node 311 and 312. Each node positions in the rotated remote topology map may be corrected based on the determined offset value between node 311 and 312. Finally the two topology maps may be combined or added to an extended topology map. From the remote topology map only node position may be used that are unknown for node 311. In the example it may be node 317 and 316. The others may be discarded.

FIG. 3d depicts exemplary embodiment of a rotated extended topology map 350. The extended topology map is based on the local topology map 310 and remote topology map 320. The extended topology map comprises nodes 311 to 316. Node 311 is located at position (0, 0). A last step may be that the extended topology map is derotated to the original orientation of the local topology map. This may be done on the previous determined angle. FIG. 3e depicts an example of a derotated extended topology map 360. FIG. 3e depicts the nodes 311 to 317. Node 311 is located at position (0, 0).

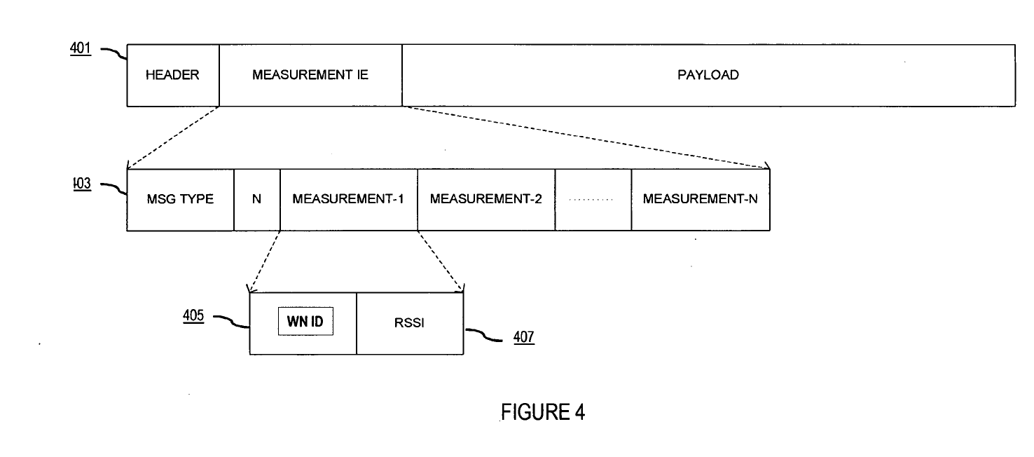

FIG. 4 depicts an example embodiment of a frame or packet or message 401 comprising a distance measurement report. The example frame or packet or message 401 comprises a header section which comprises at least an identification of the apparatus that transmits the messages. The frame or packet or message 401 comprises further a measurement information element (IE) 403 and a payload section. The payload section may be used for further data transmission. The measurement information element 403 comprises a message type (MSG TYPE) to identify the measurement information element as a distance measurement report. Beside that it comprises a parameter N that defines the number of measurement records available in the measurement IE. Each measurement record comprises a wireless node identification (WN ID) 405 and the respective distance information 407. In this example the distance information 407 is presented as RSSI. The wireless node identification identifies the wireless node from which the distance information is determined towards the apparatus that transmits the packet. The number of measurement records in a frame or packet or message may be bounded in order to avoid long frames or packets messages. This allows limiting data traffic caused by the measurement records. The frame or packet or message may be transmitted by an apparatus that has regular data to broadcast or it maybe transmitted based on a received request for a distance measurement.

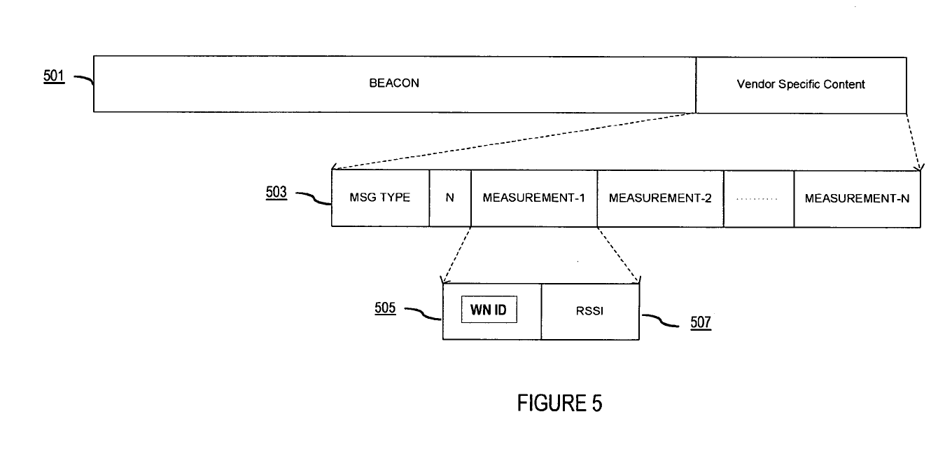

FIG. 5 depicts an example embodiment of a beacon comprising a distance measurement report. The beacon is transmitted periodically to keep surrounding wireless nodes synchronized. The example beacon 501 comprises a standard beacon part as known for example from WLAN that is broadcasted periodically and a vendor specific content section. The vendor specific content section may be used for the transmission of the distance measurement report. The distance measurement report comprises a message type (MSG TYPE) to identify the distance measurement report. Beside that it comprises a parameter N that defines the number of measurement records available in the measurement report. Each measurement record comprises a wireless node identification (WN ID) 505 and the respective distance information 507. In this example the distance information 507 is presented as RSSI. The wireless node identification identifies the wireless node from which the distance information is determined towards the apparatus that transmits the beacon. The number of measurement records in the beacon may be bounded in order to avoid long messages. This allows limiting data traffic caused by the measurement records.

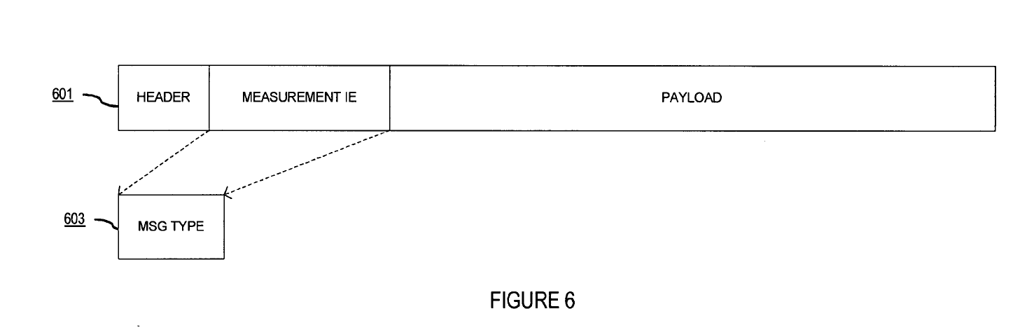

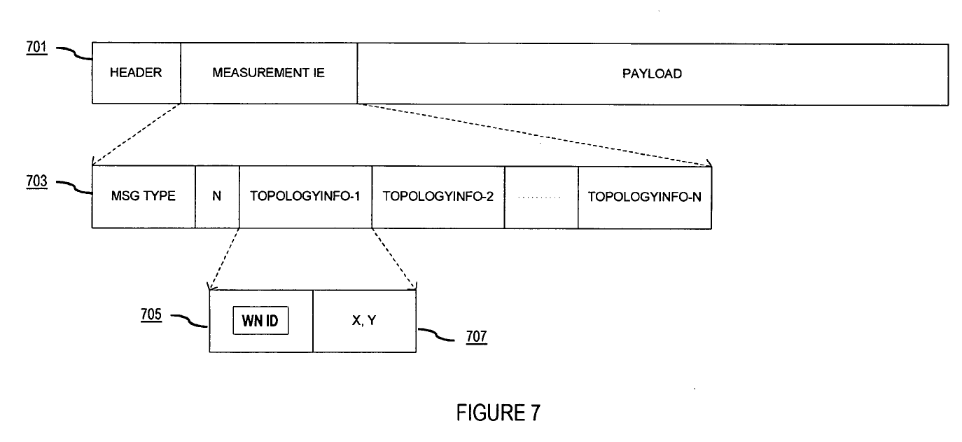

FIG. 6 depicts an example embodiment of a message for a topology map request. The topology map request may be used as request for a remote topology map by a wireless node that wants to extend its local topology map. The request may be directed to a dedicated wireless node or may be transmitted as a broadcast or multicast message to more then one wireless nodes. The example message 601 comprises a header section which comprises at least an identification of the apparatus that transmits the messages. The message 601 comprises further a measurement IE and a payload section. The payload section may be used for normal data transmission. The measurement 1E 603 comprises a message type (MSG TYPE) to identify the measurement IE as a topology map request. The wireless node that receives the message may response with a topology map response message as presented by FIG. 7.

FIG. 7 depicts an example embodiment of a message for a topology map response. The topology map response message 701 comprises a header section which comprises at least an identification of the apparatus that transmits the messages. The response message 701 comprises further a measurement IE 703 and a payload section. The payload section may be used for data transmission. The measurement IE 703 comprises a message type (MSG TYPE) to identify the measurement IE as a topology map response message. Beside that it comprises a parameter N that defines the number of topology information (TOPOLOGYINFO) available in the measurement IE. The topology information comprises wireless node identification (WN ID) 705 and the respective coordinates 707 of the wireless node. In this example the respective coordinates 707 are presented in X and Y coordinates.

In another embodiment the topology information may comprise X, Y and Z coordinates for a three dimensional representation. This three dimension topology information may be defined based on a different MSG TYPE identifier. In another embodiment the topology information may include further an indication if the comprised coordinates are real geographical or estimated coordinates. Also this may be identified by a specific MSG TYPE identifier.

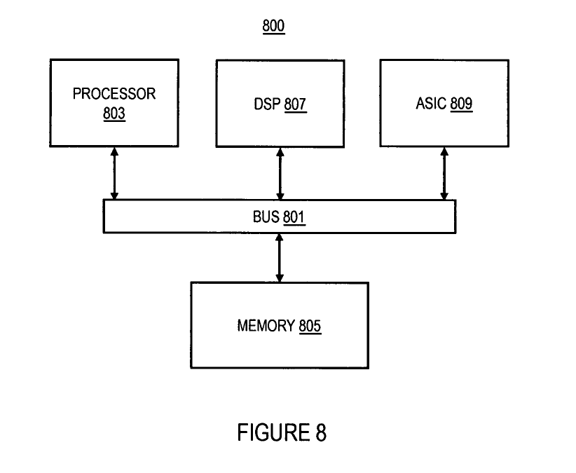

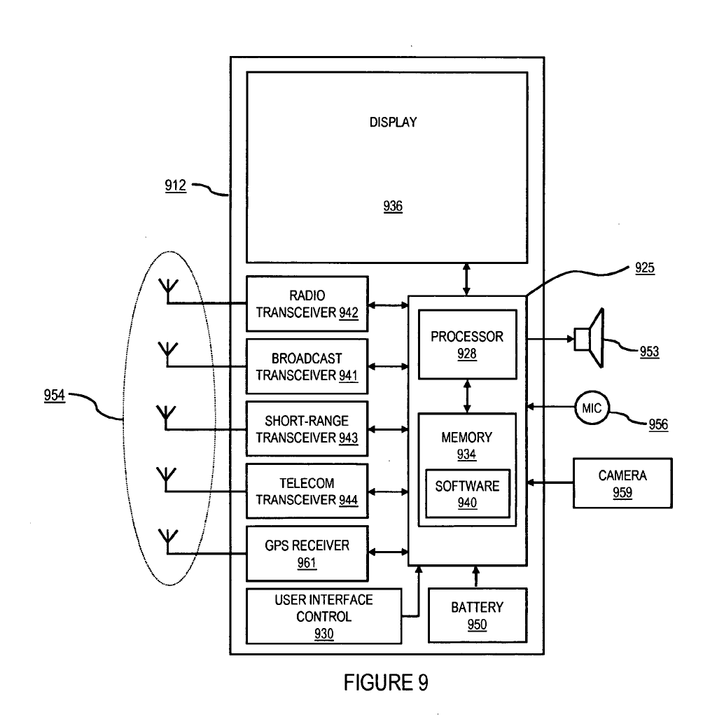

FIG. 8 depicts an example embodiment of a hardware which may be a chip set 800 upon which embodiments of the invention may be implemented. Chip set 800 is configured to provide distance and/or topology information in the mesh network 100 as described herein and includes, for instance, the processor and memory components described with respect to FIG. 9 may be incorporated in one or more physical packages. By way of example, a physical package includes an arrangement of one or more materials, components, and/or wires on a structural assembly (for example a baseboard) to provide one or more characteristics such as physical strength, conservation of size, and/or limitation of electrical interaction.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores where each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (for example sound) in real time independently of the processor 803. Similarly, an ASIC 809 may be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 may include both dynamic memory (for example RAM, magnetic disk, writable optical disk, etc.) and static memory (for example ROM, CD-ROM, etc.) for storing executable instructions that when executed perform the exemplary steps described herein to provide distance and/or topology information over a mesh network 100. The memory 905 also stores the data associated with or generated by the execution of the exemplary steps described herein.

FIG. 9 depicts an example embodiment of a wireless node like a mobile device 912 according to one or more aspects described herein. The mobile device may operate in the mesh network 100 of FIG. 1. Mobile device 912 may include a controller 925 connected to a user interface control 930, display 936 and other elements as illustrated. Controller 925 may include one or more processors 928 and one or more memories 934 storing software 940, for example client software. Mobile device 912 also may include one or more of battery 950, speaker 953 and one ore more antennas 954. User interface control 930 may include controllers or adapters configured to receive input from or provide output to a camera 959, keypad, touch screen, voice interface (for example via microphone 956), function keys, joystick, data glove, mouse and the like. Additionally or alternatively, camera 959 and microphone 956 may be configured to capture various types of content including video, audio and still images.

Computer executable instructions and data used by processor 928 and other components of mobile device 912 may be stored in a storage facility such as memory 934. Memory 934 may comprise any type or combination of read only memory (ROM) modules or random access memory (RAM) modules, including both volatile and nonvolatile memory such as disks. Software 940 may be stored within memory 934 to provide instructions to processor 928 such that when the instructions are executed, processor 928, mobile device 912 and/or other components of mobile device 912 are caused to perform various functions or methods such as those described herein. Software may include both applications and operating system software, and may include code segments, instructions, applets, pre-compiled code, compiled code, computer programs, program modules, engines, program logic, and combinations thereof. Computer executable instructions and data may further be stored on computer readable media including electrically erasable programmable read-only memory (EEPROM), flash memory or other memory technology, CD-ROM, DVD or other optical disk storage, magnetic cassettes, magnetic tape, magnetic storage and the like. Some or all of the instructions implemented by one ore more processors represented by processor 928 or other components so as to carry out the operations described herein may also be stored as hard-wired instructions (for example logic gates). For example, processor 928 could include one or more application specific integrated circuits (ASICs) configured to carry out operations such as those described herein.

The presented controller, elements or components are shown as an exemplary embodiment. In an alternative embodiment the controller, elements or components may be combined or some of them are not presented at all. Beside any components, elements or controller may be combined or separated in a different functional manner.

Mobile device 912 or its various components may be configured to transmit and/or receive, decode and process various types of transmissions including digital broadband broadcast transmissions that are based. Other digital transmission formats may alternatively be used to deliver content and information regarding availability of supplemental services. Additionally or alternatively, mobile device 912 may be configured to receive, decode and process transmissions through FM/AM Radio transceiver 942, short-range communication transceiver like for example wireless local area network (WLAN) transceiver 943, and/or telecommunications transceiver 944. Transceivers 941, 942, 943 and 944 may, alternatively, include individual transmitter and receiver components. In one or more arrangements, mobile device 912 may further include a gyroscopic sensor (not shown) configured to determine an orientation of mobile device 912. According to one or more further aspects, mobile device 912 may include a GPS receiver 961 for receiving and determining location information from one or more GPS satellites.

Although the above description of FIG. 9 generally relates to a mobile device, other apparatuses or devices or systems may include the same or similar components and perform the same or similar functions and methods. For example, a stationary computer such as a personal computer may include the components or a subset of the components described above and may be configured to perform the same or similar functions as mobile device 912 and its components. Other example apparatuses that may include one or more of the components illustrated in FIG. 9 include terminal devices, displays, mobile phones, personal digital assistants, smartphones, printer devices, information panel, television sets or set-top boxes.

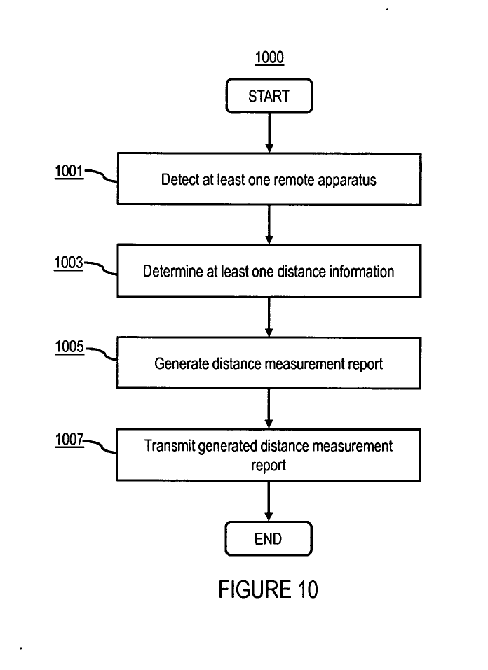

FIG. 10 depicts a flow diagram for an example distance measurement transmitting process 1000. The process 1000 presented in the FIG. 10 may be implemented for example by an apparatus as presented by FIG. 8 and/or FIG. 9. The process 1000 may start automatically on a regular basis, may be triggered by a received request to provide a distance measurement message, may start based on a user interaction or may start based on an application request. In step 1001 the apparatus detects at least one remote apparatus, wherein at least one or all of the remote apparatus is respectively identified by identification information. In step 1003 the apparatus determine at least one distance information between the apparatus and at least one or all of the at least one remote apparatus. In an embodiment there may be two or more remote apparatuses identified that are not in communication range to each other as they are too far away. But they are in communication range of the apparatus. In step 4005 the apparatus generates one ore more messages comprising for at least one or all detected remote apparatus the identification information and the determined distance information. In step 4007 the one ore more messages are transmitted by the apparatus. The transmission may be repeated on a regular basis or based on a received request. The one ore more messages may be transmitted as a broadcast or multicast message.

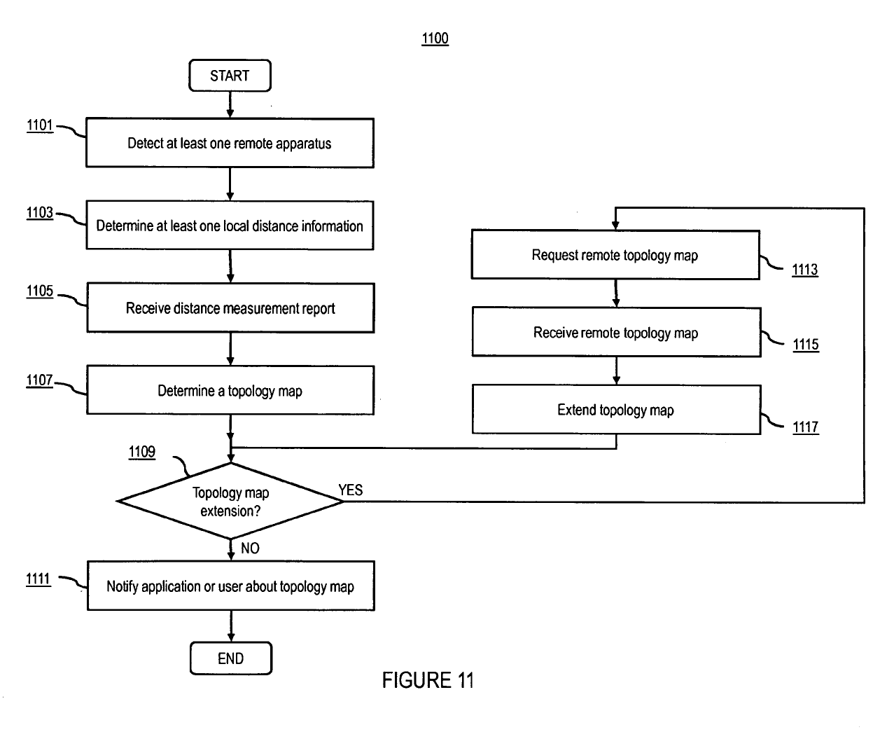

FIG. 11 depicts a flow diagram for an example local topology map generation process 1100. The process 1100 presented in the FIG. 10 may be implemented for example by an apparatus as presented in FIG. 8 and/or FIG. 9. The process 1100 may start automatically on a regular basis, may be triggered by a received request to provide a distance measurement message, may start based on a user interaction or may start based on an application request. In step 1101 the apparatus detects at least one remote apparatus, wherein at least one or all remote apparatus is respectively identified by identification information. In step 1103 the apparatus determine at least one local distance information between the apparatus and at least one or all of the at least one remote apparatus. The step may be based on a received beacon or a payload message from the remote apparatus. In step 1105 the apparatus receives a distance measurement report. The distance measurement report comprises at least one peer identification information of a peer apparatus and a peer distance information between the remote apparatus and the peer apparatus. The received measurement report may be based on one of the format as presented exemplary by FIG. 4 and FIG. 5. In step 1107 the apparatus determines a topology map based on the local distance information and identification information and the received peer identification and peer distance information. In step 1109 the apparatus determines if a topology map extension is desired. If this is not desired in step 1111 the application or user is notified about the determined topology map and the topology map may be shown on the apparatus. For the case an extension of the topology map is desired a request for a remote topology map is transmitted in step 1113. The request may be based on a message as presented exemplary by FIG. 6. This may be a dedicated request to one remote apparatus or a broadcast request. In step 1115 the apparatus receives in response to the request one or more messages, as presented exemplary by FIG. 7, from one or more remote apparatuses. The one ore more response messages comprise one ore more remote topology maps. In step 1117 the apparatus extends the topology map with the information received in response to the request. This may comprise a rotation step of the topology map and the received topology map or a flipping step of the remote topology map. It may also comprise a shifting step to align the center position of the remote topology map and a merging step of the local and remote topology map to an extended topology map. It may also comprise a derotation step to adjust the orientation of the extended topology map to the orientation of the determined topology map. The process proceeds in step 1109 as discussed above with a further extension step or may end in step 1111.

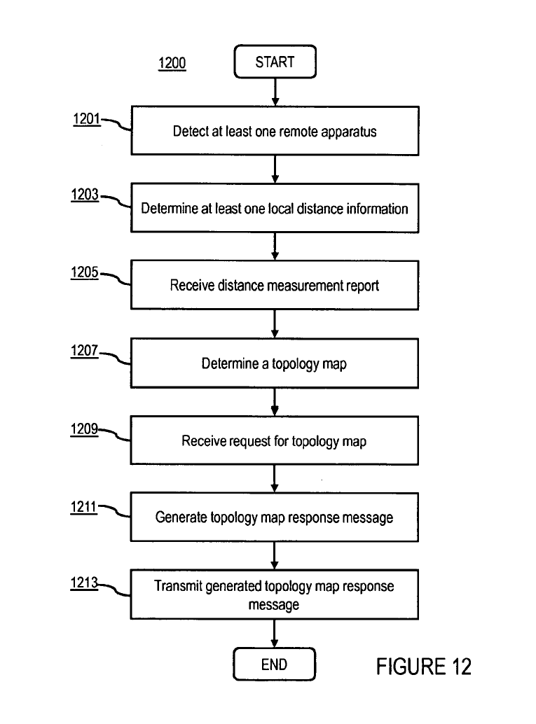

FIG. 12 depicts a flow diagram for an example topology map distribution process. The process 1200 presented in the FIG. 12 may be implemented for example by an apparatus as presented in FIG. 8 and/or FIG. 9. The process 1200 may start automatically on a regular basis, may be triggered by a received request to provide a distance measurement message, may start based on a user interaction or may start based on an application request. In step 1201 the apparatus detects at least one remote apparatus, wherein at least one or all remote apparatus is respectively identified by identification information. In step 1203 the apparatus determine at least one local distance information between the apparatus and at least one or all of the at least one remote apparatus. In step 1205 the apparatus may receive a distance measurement report. The distance measurement report comprises at least one peer identification information of a peer apparatus and a peer distance information between the remote apparatus and the peer apparatus. The received measurement report may be based on one of the format as presented exemplary by FIG. 4 and FIG. 5. In step 1207 the apparatus determines a topology map based on the local distance information and identification information and the received peer identification and peer distance information. In step 1209 the apparatus receives a request for a topology map from a remote apparatus. The request may be based on the message presented exemplary by FIG. 6. In step 1211 the apparatus generates in response to the request one or more messages that comprise the topology map. The message may be based on the structure as presented exemplary by FIG. 7. In step 1219 the apparatus transmits the topology map response message.

The steps presented in the process by FIGS. 10, 11 and 12 may be executed in an alternative or different order or concurrently with each other. Some of the steps presented in FIGS. 10, 11 and 12 may be optional and are not be executed always as the related information may be taken from some previous execution of the related process. For example the first apparatus may determine a topology may without receiving any distance measurement reports from one or more remote apparatuses.

Without in any way limiting the scope, interpretation, or application of the claims appearing below, a technical effect of one or more of the example embodiments disclosed herein is exchanging message between devices for local topology estimation. Another technical effect of one or more of the example embodiments disclosed herein is the distance determination may be based on normal data packets which may reduce generated traffic on a channel and power consumption in a device. Another technical effect of one or more of the example embodiments disclosed herein is the distribution of location information by occupying only a small amount of available wireless channel capacity. Another technical effect of one or more of the example embodiments disclosed herein is that no central unit like a server is needed for the determination of the topology map as wireless nodes may calculate the topology map on its own. This results also in a reduced traffic overhead for location information distribution. Another technical effect of one or more of the example embodiments disclosed herein is that a user may see from its mobile device how other users or devices are positioned with respect to him.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 8 and/or FIG. 9. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
detecting at least one remote apparatus by a first apparatus, wherein each of the at least one remote apparatus and first apparatus is identified by an identification information;
determining a local distance information between the first apparatus and at least one of the at least one remote apparatus;
receiving at least one distance measurement report from any one or each one of the at least one remote apparatus, comprising at least one peer identification information of at least one peer apparatus and an associated peer distance information between the remote apparatus and the at least one peer apparatus; and
determining a topology map based on the at least one identification information, local distance information, and the at least one distance measurement report, wherein the topology map comprises the at least one remote apparatus and the at least one peer apparatus.

2. The method according to claim 1, wherein further comprising at least one of:
a) wherein the first apparatus is not in direct communication range with the at least one peer apparatus;
b) wherein the identification information represents a unique address in a mesh network; and
c) wherein the topology map represents a relative position for the at least one detected remote apparatus and the at least one peer apparatus.

3. (canceled)

4. (canceled)

5. The method claim 1, wherein the local or peer distance information comprises at least one of receiver signal strength indication, time of flight indication, time of arrival indication, angle of arrival indication, phase difference indication and distance class information.

6. The method according to claim 1, further comprising at least one of:
a) wherein the at least one distance measurement report is a broadcast message transmitted periodically;
b) wherein the determining comprises minimizing a cost function; and
c) receiving a remote topology map in response to a request message.

7. (canceled)

8. (canceled)

9. The method according to claim 6, further comprising at least one of:
a) extending the topology map to include the topology map and the remote topology map; and
b) wherein the remote topology map further comprises an indication whether the at least one peer apparatus has a real geographical position.

10. The method according to claim 9, wherein the extending further comprises rotating the topology map and the remote topology map by an angle and shifting the rotated topology map by an offset value.

11. (canceled)

12. The method according to claim 1, wherein the at least one distance measurement report further comprises a remote distance information between the first apparatus and the remote apparatus and in addition an identification information of the first apparatus.

13. An apparatus comprising:
at least one processor configured to
detect at least one remote apparatus, wherein each of the at least one remote apparatus and apparatus is identified by an identification information;
determine a local distance information between the apparatus and at least one of the at least one remote apparatus;
receive at least one distance measurement report from any one or each one of the at least one remote apparatus, comprising at least one peer identification information of at least one peer apparatus and an associated peer distance information between the remote apparatus and the at least one peer apparatus; and
determine a topology map based on the at least one identification information, local distance information, and the at least one distance measurement report, wherein the topology map comprises the at least one remote apparatus and the at least one peer apparatus.

14. The apparatus according to claim 13, wherein further comprising at least one of:
a) wherein the identification information represents a unique address in a mesh network;
b) wherein the topology map represents a relative position for the at least one detected remote apparatus and at least one peer apparatus;
c) wherein the at least one processor is further configured to receive a remote topology map in response to a request message;
d) wherein the apparatus, the remote apparatus and the at least one peer apparatus are a part of a wireless mesh network; and
e) wherein the processor comprises at least one memory that contains executable instructions that if executed by the processor cause the apparatus to
detect at least one remote apparatus, wherein each of the at least one remote apparatus and the apparatus is identified by an identification information;
determine a local distance information between the apparatus and at least one of the at least one remote apparatus;
receive at least one distance measurement report from any one or each one of the at least one remote apparatus, comprising at least one peer identification information of at least one peer apparatus and an associated peer distance information between the remote apparatus and the at least one peer apparatus; and
determine a topology map based on the at least one identification information, local distance information, and the at least one distance measurement report, wherein the topology map comprises the at least one remote apparatus and the at least one peer apparatus.

15. (canceled)

16. (canceled)

17. (canceled)

18. (canceled)

19. A method comprising:
detecting at least one remote apparatus by a first apparatus, wherein each of the at least one remote apparatus and the first apparatus is identified by an identification information,
determining a distance information between the first apparatus and at least one of the at least one remote apparatus;
generating at least one distance measurement report comprising for any one or each one of the at least one of the detected remote apparatus the identification information and the distance information; and
transmitting the at least one generated distance measurement report.

20. The method according to claim 19, further comprising determining a topology map based on the at least one identification information and the distance information, wherein the topology map comprises the at least one remote apparatus and the first apparatus.

21. The method according to claim 20, further comprising transmitting the topology map in response to a received request message.

22. The method according to s claim 19, wherein the distance information comprises at least one of receiver signal strength indication, time of flight indication, time of arrival indication, angle of arrival indication, phase difference indication and distance class information.

23. The method according to claim 19, wherein the detecting, the determining, the generation or the transmitting are periodic or on request.

24. The method according to claim 19, wherein the at least one remote apparatus comprises a first remote apparatus and at least one second remote apparatus.

25. The method according to claim 24, wherein the first remote apparatus is not in direct communication range with the at least one second remote apparatus.

26. An apparatus comprising:
at least one processor configured to
detect at least one remote apparatus, wherein each of the at least one remote apparatus and the apparatus is identified by an identification information;
determine a distance information between the apparatus and at least one of the at least one remote apparatus;
generate at least one distance measurement report comprising for any one or each one of the at least one of the detected remote apparatus the identification information and the distance information; and
transmit the at least one generated distance measurement report.

27. The apparatus according to claim 26, wherein the at least one processor further configured to
determine a topology map based on the at least one identification information and the distance information, wherein the topology map comprises the at least one remote apparatus and the apparatus.

28. The apparatus according to claim 26, wherein the at least one processor comprises at least one memory that contains executable instructions that if executed by the processor cause the apparatus to
detect at least one remote apparatus, wherein each of the at least one remote apparatus and the apparatus is identified by an identification information;
determine a distance information between the apparatus and at least one of the at least one remote apparatus;
generate at least one distance measurement report comprising for any one or each one of the at least one of the detected remote apparatus the identification information and the distance information; and
transmit the at least one generated distance measurement report.

29. A computer program product comprising a non-transitory computer-readable medium having computer executable program code embodied therein for execution by at least one computer processor, the computer program code comprising:
code for detecting at least one remote apparatus by a first apparatus, wherein each of the at least one remote apparatus and the first apparatus is identified by an identification information;
code for determining a local distance information between the first apparatus and at least one of the at least one remote apparatus;
code for receiving at least one distance measurement report from any one or each one of the at least one remote apparatus, comprising at least one peer identification information of at least one peer apparatus and an associated peer distance information between the remote apparatus and the at least one peer apparatus; and
code for determining a topology map based on the at least one identification information, local distance information, and the at least one distance measurement report, wherein the topology map comprises the at least one remote apparatus and the at least one peer apparatus.

30. (canceled)

31. (canceled)

32. (canceled)

33. (canceled)

34. (canceled)
